(19) United States
(12) Patent Application Publication
(10) Pub. No.: US 2002/0157754 A1
(43) Pub. Date: Oct. 31, 2002

(54) Metallic cord for reinforcing rubber articles, in particular tyres.

(76) Inventor: Enzo Falzolgher, Milano (IT)

Correspondence Address: Finnegan, Henderson, Farabow,, Garrett & Dunner, L.L.P., 1300 I Street, N.W., Washington, DC, 20005-3315, US

(21) Appl. No.: 10/060,352

(22) Filed: Feb. 1, 2002

Related U.S. Application Data
(63) Continuation of application No. PCT/EP00/06882, filed on Jul. 19, 2000.
(60) Provisional application No. 60/156,433, filed on Sep. 28, 1999.

(30) Foreign Application Priority Data
Aug. 4, 1999 (EP) 99830507.2

(51) Int. Cl. B60C 9/00

(52) U.S. Cl. 152/527; 152/526; 152/537

(57) ABSTRACT

A reinforcing ply for rubber articles includes a plurality of parallel cords enclosed in an elastomeric matrix. Each cord includes three internal core wires and six external crown wires. The core wires and the crown wires have a same diameter. In a cross section of the reinforcing ply, a ratio between an area of the cords and an area of the elastomeric matrix is not greater than 6:10. A tire including a carcass provided with at least one carcass ply, a tread band, and a belt package is also disclosed. The belt package is provided with at least two reinforcing layers between the at least one carcass ply and the tread band. At least one of the reinforcing layers includes the reinforcing ply.

The present invention relates to a metallic cord for reinforcing rubber articles, in particular tires.

More particularly, the metallic cord to which the invention refers is of the type comprising three internal wires forming a core configuration and six external wires forming a crown configuration around them.

These cords are used as a metallic reinforcing element in rubber articles, and for this purpose are enclosed in an elastomeric matrix to create a ply.

In particular the plies to which the invention refers form the reinforcing layers of tires.

Generally, as is well known, a tire comprises a toroidal carcass formed by at least one reinforcing ply anchored to a pair of bead wires, a tread band and a belt layer between the carcass and the tread band.

Said belt layer may comprise at least two layers of rubber enclosing metallic cords of the type described above, where the cords of one layer are crossed with respect to those of the adjacent layer and relatively to the equatorial plane of the tire.

A steel cord with three core wires and six crown wires is, for example, described in the patent U.S. Pat. No. 5,609,014. This cord has a “1×9” structure which is obtained by simultaneously unwinding nine wires from nine different bobbins and feeding said wires first to a preforming device and then to a twisting machine. In a final phase this cord is subjected to deformation by compression so as to assume a substantially elliptical shape.

The core wires of the cord according to patent U.S. Pat. No. 5,609,014 are all of equal diameter, just as the six crown wires the diameter of which, however, is larger than the diameter of the core wires. In particular, the crown wires are of a diameter 1.5 to 2 times greater than that of the core wires. Moreover all the wires have a diameter which does not exceed 0.5 mm and preferably is comprised between 0.15 mm and 0.38 mm. In one example a cord is described in which the core wires have a diameter equal to 0.2 mm and the crown wires have a diameter equal to 0.35 mm. The twist pitch, equal for the core and the crown wires, is preferably between 10 mm and 20 mm.

The cord according to patent U.S. Pat. No. 5,609,014 is compared with a conventional cord of the “3+6” type formed of three core wires and six crown wires, the former wound together and the latter wound round the former in a manufacturing cycle comprising two different phases: a first phase of stranding of the core wires and a second phase of winding of the crown wires around the core wires. The drawings of U.S. Pat. No. 5,609,014 show a section through the conventional “3+6” cord and further sections through the “1×9” cord described in said patent, highlighting, in the case of the conventional cord, a circular section with the core wires in close contact with each other and forming a star-shaped configuration, while in the “1×9” cord elliptical sections are shown, the ratio between the two different diameters of which being of between 1.05 and 1.20.

In the cord according to U.S. Pat. No. 5,609,014 the crown wires are more widely spaced from each other than in the conventional “3+6” cord and the core wires have open positions compared with the position of mutual contact described above.

The cords with three core wires and six crown wires as in the prior art, even though widely used in the manufacture of tires, are not totally satisfactory. In fact, it should be noted that the use of said cords in the rubber plies, used for producing the belt layer of a tire, often causes some drawbacks such as the detachment of the cords from the elastomeric material, especially in the vicinity of the extremities of the individual belts.

The Applicant has perceived that said detachment phenomenona are not due to irregular working conditions of the tire, but to the continuous high mechanical stresses to which the tire is subjected, e.g. during high speed travel (high centrifugal force) or during slip forces which act on the tire during cornering.

The Applicant has, therefore, perceived the need to obtain a new structure for a metallic cord in order to improve the performance of said rubber plies, particularly when used for the belt strips of a tire.

The Applicant has noted that, in order to eliminate the defects found in the plies, the prior art increasingly gave the most external wires (i.e., the crown wires) of the cord the function of a sheath enclosing all the core wires. In order to do this, the tendency among designers has been to use core wires of a diameter smaller than the diameter of the crown wires. This design tendency is accompanied by a good visual assessment of the cord itself which shows a circular or elliptical transverse section which gives a sense of constructional regularity to which a certain reliability in working conditions can be conceded.

Moreover the Applicant has noted that, in order to guarantee improved performance of the tires under particular stresses, the tendency of the state of the art has been to increase the density of the wires enclosed in the elastomeric ply, particularly in that used for the belt strips.

The Applicant has perceived that one of the possible causes of the detachment phenomena mentioned above may lie in the choice of an excessive density of the cords inside the ply, which means there is little rubber amount between adjacent cords in said ply.

The Applicant found that a “3+6” type cord, with all the wires of equal diameter, allows good penetration of the rubber from the outside towards the core wires, offering good resistance to the stresses in working conditions.

It can also be used in the plies for belt strips with the consequent elimination, or at least the substantial reduction, of the phenomena, described above, of ripping of the rubber and detachment between the rubber and the metall at the extremities of the belt strips thanks to the possibility of using reduced densities.

The first aspect of the invention is therefore a steel cord for reinforcing rubber articles comprising three core wires and, wound around said core wires, six crown wires, the cord being characterized in that all the wires have the same diameter, said diameter being comprised between 0.30 mm and 0.40 mm.

Said wires are preferably in HT steel and have a diameter of 0.35 mm.

Preferably the core wires of said cord are helically wound together according to a first winding pitch and the crown wires are twisted and helically wound around the core wires according to a second winding pitch.

In some embodiments said first and second winding pitches are between 10 mm and 20 mm.

In accordance with one embodiment of the cord of the invention, at least one of the core wires in at least one of the cross sections along the length of the cord, is positioned on the curvilinear (circular or helical) profile which externally defines said crown configuration.

According to a second aspect, the invention relates to a reinforcing ply for rubber articles comprising a plurality of metallic cords as previously defined which are arranged parallel to each other and enclosed in an elastomeric matrix.

Preferably the reinforcing ply comprises cords arranged with a density of between 40 cords/dm and 50 cords/dm.

In other embodiments, the “RM” value, which defines the ratio between the area of the cross section of the metall and the area of the cross section of the elastomeric material on the cross section of the metallic ply, is not greater than 60%; this “RM” value is usually calculated as the product of the apparent diameter of the cord multiplied by the density.

Preferably, the reinforcing ply is made with a total thickness between 190 mm and 250 mm.

In a third aspect the invention relates to a tire comprising a belt with at least two reinforcing layers, at least one of which is formed of a ply as previously defined.

The present invention will be better understood with the aid of the description which follows and the enclosed drawings supplied only as non-restrictive examples, in which:

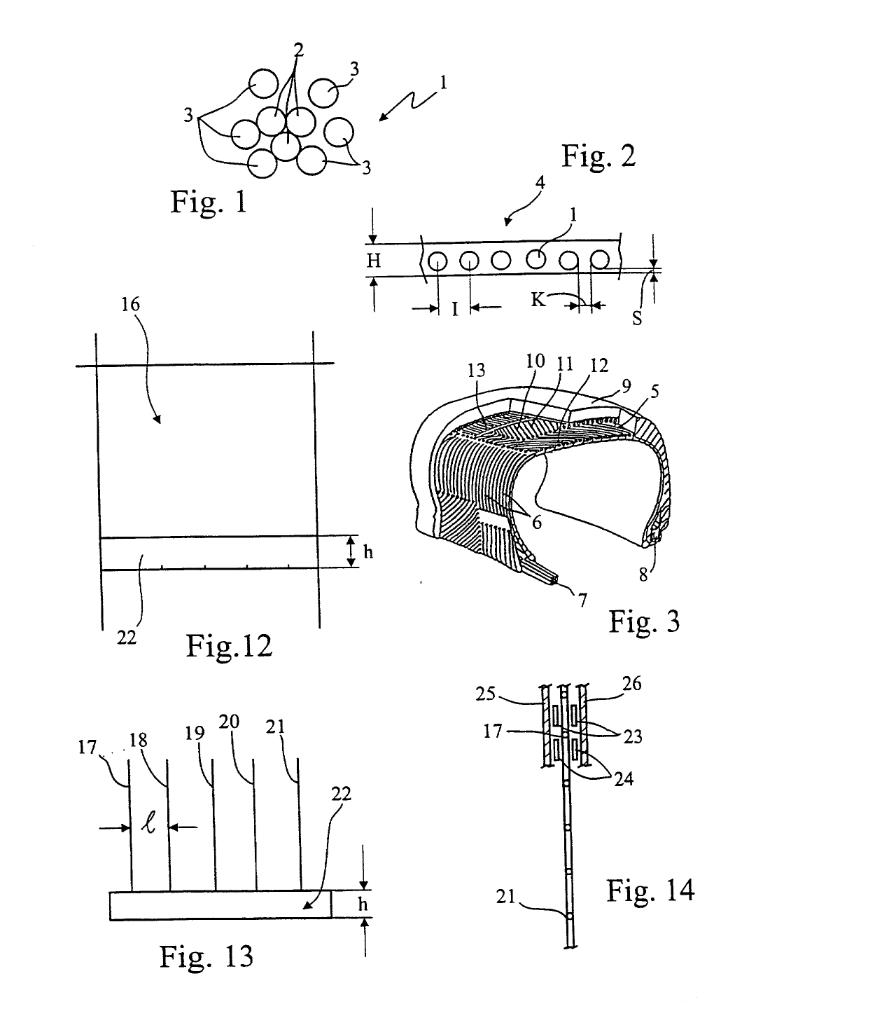

FIG. 1 shows a cross section of a cord according to the invention;

FIG. 2 shows a partial cross section of an elastomeric ply enclosing a plurality of cords of the type shown in FIG. 1;

FIG. 3 shows a partial perspective view of a tire provided with the ply shown in FIG. 2;

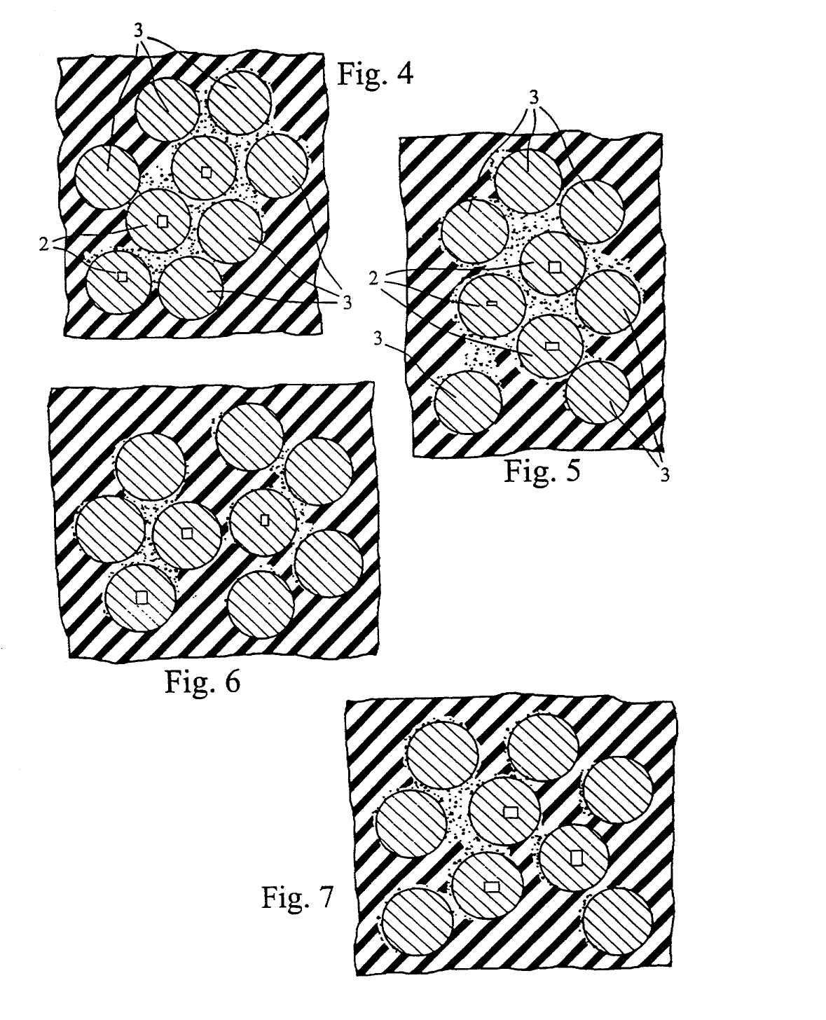

FIGS. 4-7 show partial cross sections of a cord according to the invention, said sections having been enlarged under an electron microscope;

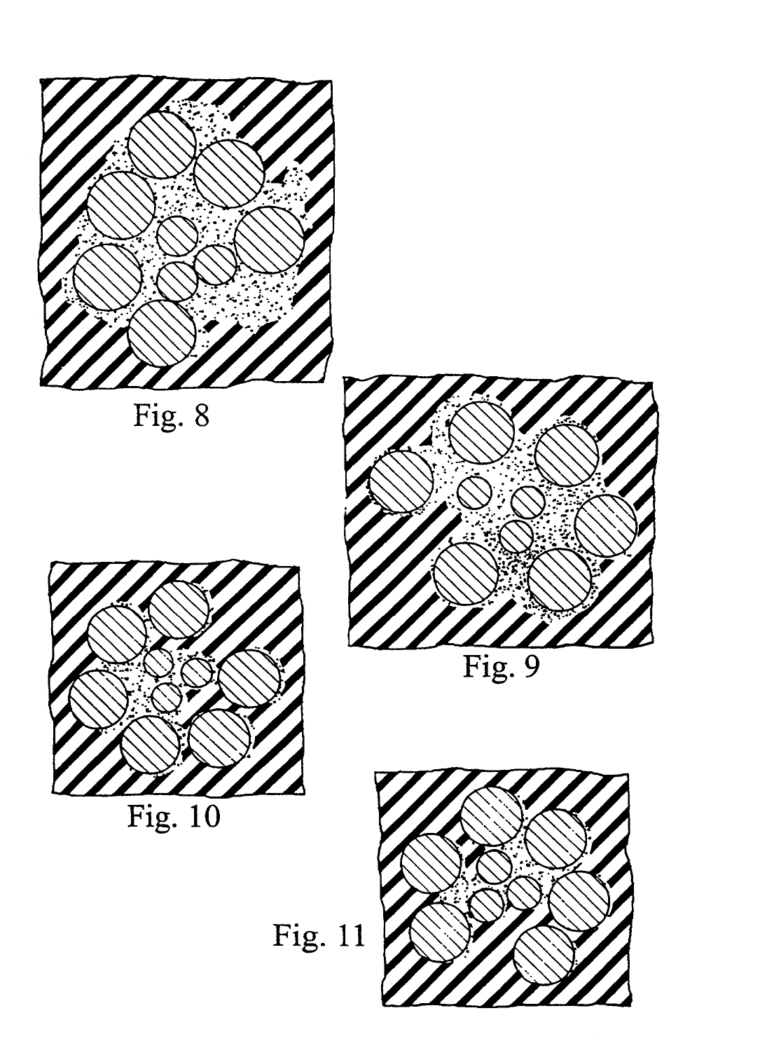

FIGS. 8-11 show partial cross sections of a cord of the known type, said sections having been enlarged under an electron microscope;

FIG. 12 shows a partial top view of a ply according to the invention;

FIG. 13 shows the ply of FIG. 12 prepared for a test in which the core wires of a cord according to the invention are withdrawn;

FIG. 14 shows a device for carrying out said withdrawal test.

In FIG. 1, reference sign 1 indicates a steel cord according to the invention.

Cord 1 comprises three core wires 2 and six crown wires 3. The core wires and the crown wires have equal diameter, said diameter being equal to 0.35 mm.

The cord is of the “3+6” type and is generally constructed by means of a manufacturing cycle based on three distinct phases: a first phase in which the core wires are twisted twice, a second phase in which the core wires undergo an untwisting operation and assume a parallel configuration, a third phase in which the six crown wires are twisted twice and at the same time are helically wound around the core wires.

Preferably, in a final phase the cord is passed through a suitable device in which said cord is subjected to specific deformations, known as “false twists”, having the purpose of annulling the internal stresses induced in the cord by the stranding, said internal stresses being responsible for the phenomenon known as “flaring” according to which the wires separate from each other at the ends of a cut cord.

The wires are produced in HT steel (with a high carbon content, >80%), having a specific breaking load equal to at least 3,000 MPa.

The resulting cord is identified by the code 3×0.35+6×0.35 HT with the same winding direction, preferably “S”, both for the core wires and for the crown wires.

According to a particular embodiment, the first pitch of the core wires of said cord is equal to 11 mm and the second pitch of the crown wires is equal to 18 mm.

In a further embodiment, the core wires and the crown wires have the same pitch, for example 18 mm.

The cord of the invention can be used as a reinforcing element for rubber articles.

The manufacture of these plies is carried out by unwinding from a plurality of bobbins an equal number of cords subjected to a predetermined traction force supplied downstream of a device known with the name of calender. In the calender the cords pass through a pair of rolls which, turning in opposite directions the one relative to the other, enclose said cords in the space between two sheets of elastomeric material.

FIG. 2 shows a partial cross section of a ply 4 according to the invention.

Ply 4 can be used in the production of a plurality of rubber articles. More particularly, the ply according to the invention can be used in a tire of the type shown in FIG. 3.

FIG. 3 shows a tire 5, of the “radial” type, comprising: a carcass formed of at least one ply 6 turned up at the ends in the form of a loop to enclose a pair of bead wires 7, 8 for assembling the tire on a wheel rim (not shown); a tread band 9 and a belt layer 10 placed between the tread band and the carcass ply.

Belt layer 10 includes, in turn, three reinforcing layers: two layers 11, 12 formed of rubberized plies enclosing metallic cords crossed over each other and with respect to the direction of the equatorial plane and preferably also a third layer 13, radially more external than the first two, formed of a rubberized ply enclosing polyamidic fibres circumferentially positioned.

The ply of the invention is used in one or both of said reinforcing layers 11, 12.

Table 1 compares two plies which can be used in the tire of FIG. 3: a first ply according to the invention and a second ply of the prior art.

The prior art ply presents, enclosed in an elastomeric matrix, a plurality of C70 carbon steel cords (carbon <80%), each of which includes three core wires with diameter equal to 0.20 mm and six crown wires with diameter equal to 0.35 mm.

The ply of the invention presents a plurality of steel cords with a high carbon content (C80-C82, carbon ≧80%) each of which includes three core wires and six crown wires with diameter equal to 0.35 mm.

TABLE 1

| | Cord of the | Cord of the |
|---|---|---|
| Cord type | invention | prior art |
| Apparent diameter | 1.37 | 1.13 |
| Ø (mm) | | |
| Metallic filler | 61.65 | 73.4 |
| RM % | | |
| Center distance | 2.22 | 1.54 |
| I (mm) | | |
| Rubber between cords | 0.85 | 0.41 |
| K (mm) | | |
| Total thickness | 2.20 | 1.90 |
| H (mm) | | |
| Adhesive sheet | 0.415 | 0.385 |
| thickness | | |
| S (mm) | | |
| Density | 45 | 65 |
| cords/dm | | |
| Average breaking load | 2340 | 1670 |
| (N) | | |
| Ultimate elongation | 2.16 | 2.5 |
| (%) | | |

where:

the apparent diameter Ø of the cord according to the invention is calculated by known methods using the formula: 2.16×0.35+2×0.35=1.37;

the apparent diameter Ø of the cord according to the prior art is calculated using the formula: 2.16×0.20+2×0.35=1.13;

RM represents, as a percentage, the metallic filler inside the ply and is expressed as the product of the density multiplied by the apparent diameter Ø.

Table 1 shows that the ply according to the invention has a larger amount of rubber between adjacent cords than a ply of the prior art.

Advantageously, the increased amount of rubber is intended as an increased attachment of the cords to the rubber of the tire according to the invention; in practice this characteristic eliminates the risk of detachments of the cords at the end of the ply due to excessive reduction of the amount of rubber between adjacent cords.

This favourable result is more significant if we consider that it has been obtained with a reduction in the density of the cords and of the metallic filler in the ply without decreasing its resistance to stresses.

Moreover, the cord according to the invention shows good penetration of the rubber from the crown towards the core, fact which improves resistance to corrosion and the life of the cord, and therefore, of the tire which includes elastomeric plies enclosing this type of cord.

Tests were carried out in order to confirm this positive result by comparing two different plies: a first ply incorporating the cord of the invention and a second ply incorporating the known cord of the prior art. The cords had the same “3+6” structure, the core wires had a 11 mm pitch and the crown wires had a 18 mm pitch.

The test conditions, identical for both the compared cords, were carried out according to the following steps:

a) the ply comprising only one cord enclosed in raw rubber was placed in a bath of molten sulphur and kept inside of it for two days at a temperature of 105° C. until it was bakelized;

b) the raw ply was then p-laced between two plates and vulcanized at a pressure of 30 KN and at a vulcanizing temperature of 151° C. for 40 minutes.

Following said steps the results shown in FIGS. 4-7 for the cord of the invention and in FIGS. 8-11 for the cord of the prior art were obtained. In particular, FIGS. 4, 5 and 8, 9 show the cross section of the ply at the end of stage a) and FIGS. 6, 7 and 10, 11 show the cross section of the ply at the end of stage b).

In order to better understand FIGS. 4-7 relating to the cord of the invention, core wire 2 have been marked with a white square.

The light patches visible in FIGS. 4-11 indicate the presence of sulphur between the wires, therefore the areas relative to said light patches show that the rubber has not penetrated into these zones.

FIGS. 4-7 show an extension of the light patches lower than the extension of the light patches of FIGS. 8-11 relative to the cord of the prior art both at the end of stage a) and at the end of stage b). Therefore it must be concluded that the cord according to the invention allows a better penetration of the rubber towards the core wires.

In order to better assess and quantitatively confirm the penetration of the rubber into the two cords under comparison, a comparative test was carried out on the force required to withdraw the rubberized and vulcanized core wires.

This test is based on the fact that higher withdrawal forces correspond to better attachment between the core wires and the rubber thanks to a more capillary penetration of the rubber into the cord.

The test has been carried out on both the compared cords using the following methods.

First, a strip of raw ply 16 (FIG. 12) with length and width equal to 20 cm was used.

As shown in FIG. 13 all the cords with the exception of five cords 17 to 21, distanced from each other by a length “l” equal to 20-25 mm were removed from strip 16. Moreover all the rubber was removed from strip 16 except for a portion 22 of a width equal to “l” and height “h” equal to 3 cm. Portion 22 of strip 16 was vulcanized in a known device of the plenum chamber type by using an air pressure equal to 10 atm. After vulcanization, the crown portion of each cord was removed by cutting operations. Then each core of the five cords, taken individually, was subjected to traction by using the method described hereinbelow with the help of FIG. 15.

FIG. 14 shows in detail the test carried out on one of five cords 17-21 belonging to portion 22 of strip 16. As shown, two pairs of 10 cm-wide metallic plates 24, 25 were placed in contact with the lateral surfaces of cord 17, and pressure was applied on these plates from opposite sides by two flat clamps 25, 26. Cord 17 was subjected to traction and the force necessary to withdraw it from the rubber was measured. The same procedure was carried out on remaining cords 18-21.

Table 2 shows the values of the forces necessary for the withdrawal of the core from the ply, first for the cord according to the invention and then for the cord according to the prior art.

TABLE 2

| | Withdrawal load for the | Withdrawal load for the |
|---|---|---|
| Test | cord according to the | cord according to the |
| piece | invention (N) | prior art (N) |
| cord 1 | 413.2 | 105.30 |
| cord 2 | 265.3 | 72.16 |
| cord 3 | 365.2 | 76.53 |
| cord 4 | 283.7 | 45.54 |
| cord 5 | 255.3 | 78.19 |
| average | 316.5 | 75.5 |
| value | | |

The values in Table 2 show that the arithmetic average value of the withdrawal load of the core of a cord according to the invention is about five times higher than that of a cord according to the prior art.

Therefore it can be stated that the penetration of the rubber from the outside towards the core wires is considerably superior in the case of the cord according to the invention.

The test was also repeated by using a cord according to the invention containing core and crown wires with the same winding pitch, equal to 18 mm. This further test also confirmed the validity of the results previously obtained.

It does not seem possible to explain some of these results since the obtained values are appreciably superior to those which might be expected from an examination of the previous FIGS. 6, 7 and 10, 11.

The Applicant, in order to explain this surprising result and supply a possible explanation of the results, presumes that the answer is to be found in the transverse sections of FIGS. 4, 5 and 8, 9 respectively. Should this hypothesis not be correct, it would not, however, limit or damage the validity of the invention.

In FIGS. 4, 5 it is possible to note that one of core wires 2 of the cord according to the invention is displaced from the centre towards the outside and is positioned on the theoretical curvilinear profile on which all the crown wires are to be found. The other cross sections of the same cord, illustrated in FIGS. 6, 7, show all the three core wires in an internal position with respect to the crown wires.

The Applicant therefore considers this situation of “decentring” of one of the core wires in the cord according to the invention, even though limited to one cross section of the cord, may produce beneficial effects along the cord, both above and below said section. Said “decentring” seems to cause an unpredictable irregularity among the wires, and in particular to disorient their geometry to the point where the spaces between the wires are increased allowing the rubber to pass from the outside towards the interior of the cord.

This theory would seem to be confirmed by the fact that the cross sections of FIGS. 8-11 relating to a cord according to the prior art do not show any “decentring” of one of the core wires and therefore rule out the hypothesised creation of further ways of access for the rubber from the exterior to the interior.

For the sake of completeness, similar cross sections of the cord according to the invention subjected to stages a) and b) as above, but made with a single pitch equal to 18 mm, also show the abovementioned “decentring” of one of the core wires with respect to the others.

Therefore, in this version also, characterized by higher average values for the withdrawal loads of the core wires compared with the values of a cord of the prior art, this hypothesis seems to be justified and to explain the excellent penetration of the rubber from the outside towards the interior of the cord.

The invention is not strictly limited to the above description, since it includes all those solutions and alternative contrivances which, while not specifically described here, may nonetheless easily be deduced by anyone skilled in the art on the basis of the present inventive solution.

1. Cord for reinforcing rubber articles comprising three internal core wires and six external crown wires, characterized in that said core wires and crown wires have the same diameter of between 0.30 mm and 0.40 mm.

2. Cord according to claim 1, characterized in that said wires are in HT steel.

3. Cord according to claim 1, characterized in that said wires have a diameter of 0.35 mm.

4. Cord according to claim 1, characterized in that said core wires are wound together at a first winding pitch and said crown wires are twisted and wound around said core wires according to a second winding pitch.

5. Cord according to claim 1, characterized in that at least one of said core wires, in at least one of the cross sections of said cord, is positioned on the curvilinear profile externally defining the configuration of said crown wires.

6. Cord according to claim 4, characterized in that said first and said second winding pitches are different, the first being shorter than the second.

7. Cord according to claim 4, characterized in that said first winding pitch is between 10 mm and 20 mm.

8. Cord according to claim 4, characterized in that said second winding pitch is between 10 mm and 20 mm.

9. Cord according to claim 4, characterized in that said first winding pitch and said second winding pitch coincide.

10. Cord according to claim 6, characterized in that said first winding pitch is equal to 11 mm and said second winding pitch is equal to 18 mm.

11. Reinforcing ply for rubber articles comprising a plurality of parallel cords enclosed in an elastomeric matrix, characterized in that the core wires and the crown wires of said cords have the same diameter of between 0.30 mm and 0.40 mm.

12. Reinforcing ply according to claim 11, characterized in that said wires are in HT steel.

13. Reinforcing ply according to claim 11, characterized in that said core wires are wound together at a first winding pitch and said crown wires are twisted and wound around said core wires at a second winding pitch.

14. Reinforcing ply according to claim 11, characterized in that at least one of said core wires, in at least one of the cross sections of said cord, is positioned on the curvilinear profile externally defining the configuration of said crown wires.

15. Reinforcing ply according to claim 11, characterized in that said cords have a density of between 40 cords/dm and 50 cords/dm.

16. Reinforcing ply according to claim 11, characterized in that the “RM” value for the metallic filling in said ply does not exceed 60%.

17. Tire comprising a carcass with at least one reinforcing ply, a tread band and a belt package provided with at least two reinforcing layers between said carcass and said tread, characterized in that at least one of said reinforcing layers is formed of a reinforcing ply comprising a plurality of cords, the core wires and the crown wires of said cords having the same diameter, said diameter being of between 0.30 mm and 0.40 mm.

18. Tire according to claim 17, characterized in that said wires are in HT steel.
